(19) United States
(12) Patent Application Publication
(10) Pub. No.: US 2012/0256060 A1
(43) Pub. Date: Oct. 11, 2012

(54) Jack system for wall displays

(76) Inventor: Kent G. West, Barrington Hills, IL (US)

(21) Appl. No.: 13/066,092

(22) Filed: Apr. 6, 2011

(51) Int. Cl. F16M 11/24

(52) U.S. Cl. 248/157

(57) ABSTRACT

A jack system for supporting and transporting display arrangements, such as wall displays in commercial as well as residential settings, is capable of positioning between a movable load-bearing position and a stationary position. The jack system includes a display support adapted for supporting a wall display or vignette and at least one caster assembly carried by the display support for providing rolling movement of the display support. At least one jack assembly is mounted to the display support and includes an upstanding jack stand and a jack carried by the jack stand and is adapted to position the display support and the at least one caster assembly to a movable load-bearing position and to a the stationary position.

### FIELD OF THE INVENTION

The present invention relates to a jack system for supporting wall displays, and in particular, a jack system positionable between a movable load-bearing position and a stationary position.

### BACKGROUND OF THE INVENTION

Display arrangements such as wall displays or vignettes provide customers an idea of what items being displayed will look like when installed in their home, apartment, or office. Retail stores often use wall displays to showcase different domestic and commercial environments, such as kitchens, bedrooms, living rooms, bathrooms, washrooms, and offices.

Wall displays may typically be erected on-site at the store location. Such on-site erection, however, is time-consuming, noisy, and generally disruptive.

In other examples, wall displays may be constructed off-site in whole or in part in an effort to reduce on-site erection time. This requires the wall displays to be transported to the store, loaded onto dollies, and rolled to a particular store location for display. Oftentimes, many workers are needed to load and then remove the preconstructed wall displays and position them at the correct locations.

Additionally, many dollies used to transport the wall displays do not have a proper braking mechanism for maintaining and stabilizing the wall display at a particular location. Lack of a braking mechanism may cause cumbersome transport requiring the workers' constant attention so as to assure the wall display and the dolly do not roll away.

Other types of dollies may include a brake mechanism used in association with attached caster assemblies. These types of brake mechanisms provide braking action by locking the caster assemblies thereby preventing rolling movement. These types of braking mechanisms, however, may not provide sufficient braking force when the dolly is positioned on an inclined surface or when supporting heavier loads such as wall displays.

Accordingly, improvements in support and transport of wall displays are still being sought.

### SUMMARY OF THE INVENTION

A jack system useful for supporting and transporting wall displays used at stores or residences is provided. The jack system includes a display support for supporting the wall display, at least one caster assembly carried by the support and positioned underneath for providing rolling movement of the display support and a jack mounted to the support. This permits a user to transport the wall display to various locations for display and anchor the display in place.

The jack system includes a jack stand, connected to the display support and having a jack securely mounted thereto. Together, the jack stand and the jack function as a brake for shifting the jack system between a movable load-bearing position capable of rolling movement and a stationary, braked position. In some embodiments, the jack system can include upstanding jack stands removably connected to opposite ends of the display support.

Many different types of jacks can be used within the jack system including traditional mechanical and hydraulic jacks. In one example, the jack can be an axially translating screw jack having a generally elongate, cylindrical, telescoping body. A first upper portion of the jack includes a crank handle and is securely mounted to the jack stand. A second lower portion of the jack includes a pad or a braking foot and is capable of upward and downward telescoping movement relative to the first upper portion. In this example, the jack is actuated by rotation of the crank handle causing the braking foot to move downwardly and contact a surface below the display support, e.g., the ground. The contact with the ground causes the jack assembly to be supported, at least in part, by the braking foot, and thereby causes resistance to rolling movement of the display support. Continued rotation of the crank handle elevates the display support and the at least one caster assembly thereby further inhibiting rolling movement while providing a sturdy support for the jack system as well as the wall display carried by the display support.

### BRIEF DESCRIPTION OF THE DRAWINGS

In the drawings,

FIG. 1 is a perspective view of a jack system according to the principles of the present invention;

FIG. 2 is a perspective view of a jack assembly including a jack stand and a jack mounted thereto;

FIG. 3 is a perspective view of a display support that utilizes the jack system;

FIG. 4 is a perspective view of the jack stand shown in FIG. 2; and

FIG. 5 is a perspective view of a pair of jack systems supporting a wall display.

### DESCRIPTION OF THE PREFERRED EMBODIMENTS

The invention disclosed herein is, of course, susceptible of embodiment in many forms. Shown in the drawings and described herein below in detail are the preferred embodiments of the invention. It is to be understood, however, that the present disclosure is an exemplification of the principles of the invention and does not limit the invention to the illustrated embodiments.

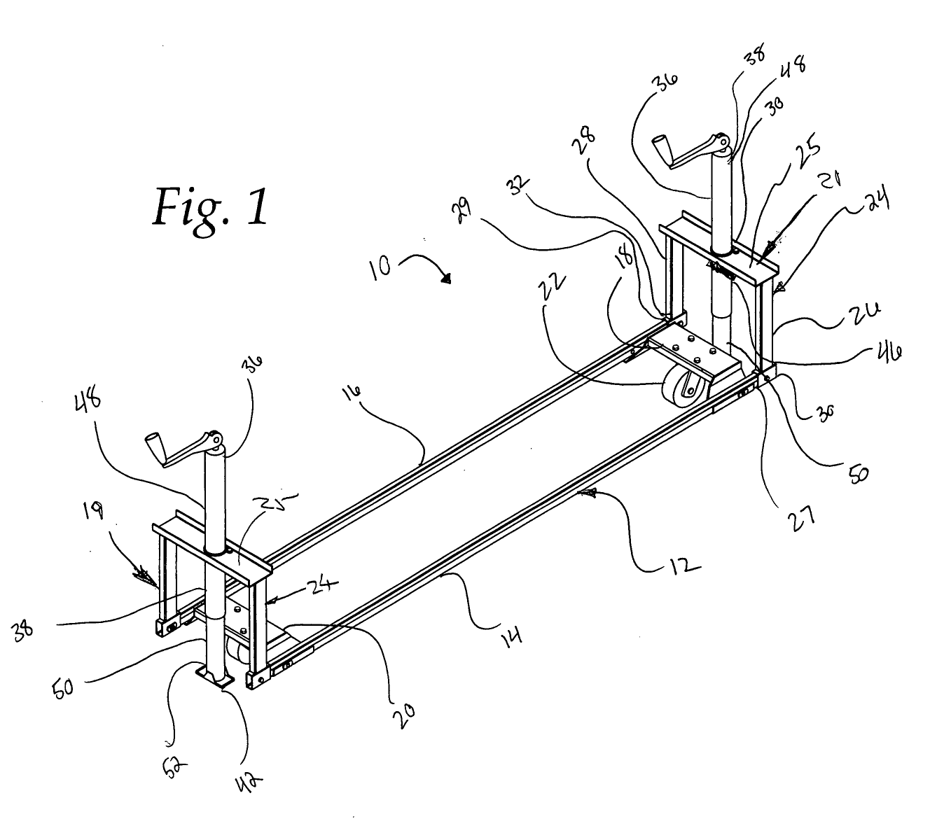

A jack system 10, as generally shown in FIG. 1, can be used to support and transport wall displays or vignettes to different locations within warehouses, factories, commercial or retail stores, residences, or any other number of locations. Wall displays may be any type of general display arrangement in a commercial or residential setting, such as any wall or structure supporting cabinets, doors, dressers, mirrors, computer equipment, or any other type of load or attachment.

The jack system 10 can be used to support and transport loads other than wall displays as well. For example, furniture, hardware supplies, timber or any other type of load or material may be supported and transported by the jack system 10.

The jack system 10 provides support for wall displays and is capable of moving between a movable load-bearing state and a stationary state. While in the movable load-bearing state, the jack system 10 is capable of rolling movement for transporting the wall display. Once the wall display is transported to a desired location, the jack system 10 can be shifted from the load-bearing state to the stationary state. While in the stationary state, a brake is engaged, and the jack system 10 is sturdily positioned so as to generally resist rolling movement. The wall display can then either be removed from the jack system 10 and configured for a desired display or it can be displayed while the jack system 10 remains in place.

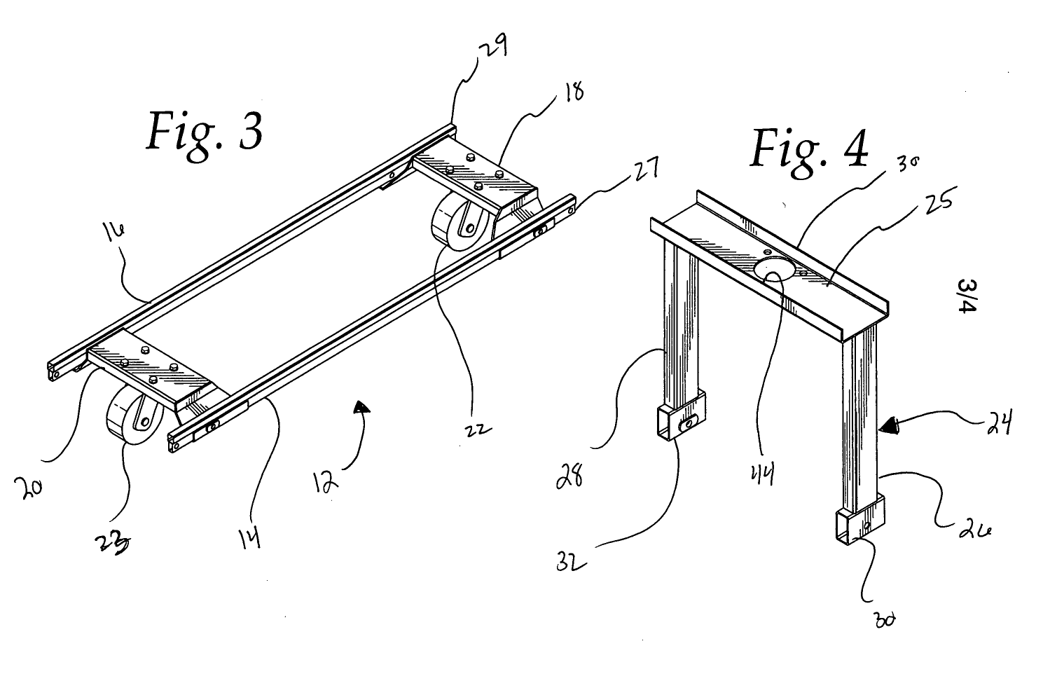

Referring to FIGS. 1 and 3, the jack system 10 includes a display support or frame 12 for carrying the wall display and at least one caster assembly 22 is carried by support 12. The display support 12 includes two generally parallel rails 14 and 16 connected by bridge portions 18 and 20. In this particular example, each of the bridge portions 18 and 20 are fastened orthogonally to each of the generally parallel rails 14 and 16 by bolts, screws, or any other fastener known in the art such that rails 14 and 16 are kept spaced from one another. This structural configuration provides a sturdy display frame capable of supporting a variety of wall displays. The display support can also include other types of frames, structures, or platforms capable of supporting and transporting loads as is known in the art.

As best seen in FIG. 3, the jack system 10 includes a pair of opposed caster assemblies 22 and 23 disposed below the display support 12 for permitting movement of the jack system 10 and display support 12. In the preferred embodiment and as illustrated in FIGS. 1 and 3, the jack system can include two caster assemblies 22 and 23 each bolted to respective bridge portions 18 and 20 at an underneath surface of each. In this configuration, the caster assemblies 22 and 23 extend below and support the display support 12.

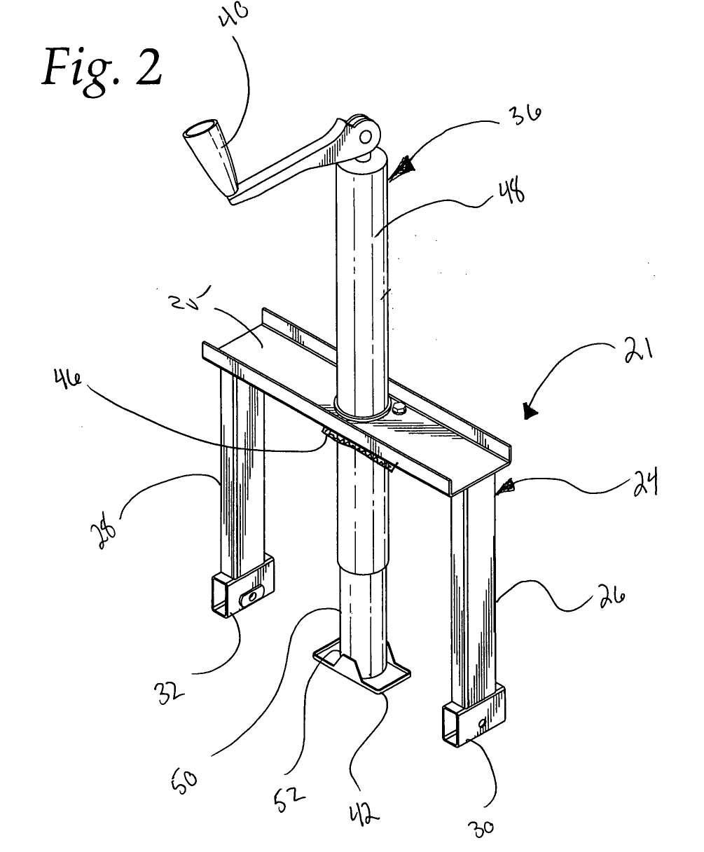

As shown in FIGS. 1 and 2, the jack system 10 includes at least one jack assembly 21 for mounting to the display support 12 including a jack stand 24 and a jack 36. Jack assembly 21 acts as a brake for resisting rolling movement of the jack system 10 and also for elevating display support 12. The jack stand 24 shown in FIGS. 2 and 4 includes upper bridge portion 25 having a mid-portion 30 located between a pair of depending legs 26 and 28. Each of the depending legs 26 and 28 include mountable apertured feet portions 30 and 32 capable of being slidably received onto, and being secured proximate to end portions 27 and 29 of each of the parallel rails 14 and 16. Each jack stand 24 can be mounted to the display support 12 by bolts, screws, or any other fastener generally known in the art.

The jack 36 can be any type of jack known in the art such as a traditional mechanical jack, screw jack, hydraulic jack, rack-and-lever jack, and the like. In this example, the jack 36 is an axially translating screw jack having a generally elongate and cylindrical body. An upper portion 48 of the jack is securely mounted to the jack stand 24 and includes a crank handle 40 for operating the jack 36. The crank handle 40 is capable of rotation in a generally clockwise or counterclockwise direction for raising or lowering the display support 12. Any other type of handle, crank or actuator known in the art can be used for operating the jack.

A lower portion 50 of the jack can be adapted for movement relative to the upper portion 48 and terminates at a distal end 52 in a braking foot or pad 42. The braking foot 42 can have a generally rectangular or round configuration and a lower surface adapted for firm engagement with the ground, and for positioning the jack system 10 between a movable load-bearing state and a stationary state.

As shown in FIG. 4, upper bridge portion 25 of the jack stand 24 carries a pair of depending legs 26 and 28. An opening 44 is generally located at the mid-portion 30 configured for receiving the jack 36. The upper portion 48 of the jack 36 can also include a generally rectangular support or mounting plate 44 for mounting the jack 36 to a lower surface of the bridge portion 25. Depending legs 26 and 28 at their respective extremities are provided with hollow feet 30 and 32 having apertures sized to receive end portions of rails 14 and 16.

In this illustrated example, the jack 36 can be used to transition the jack system 10 from a movable, load-bearing state to a stationary and braked state. The upper portion 48 of the jack is securely fastened to the jack stand 24 while the lower portion 50 of the jack is capable of either upward or downward movement in response to turning of the crank handle 40. As the crank handle 40 is rotated in a particular direction, the lower portion 50 moves downwardly causing the braking foot or pad 42 to contact the underlying surface. The contact with and the associated frictional force between the braking foot or pad 42 and the underlying surface reduce the ability of the caster assemblies 22 and 23 to provide rolling movement to the jack system 10. Continued rotation of the crank handle 40 causes the display support 12 and the caster assemblies 22 and 23 to rise, thereby inhibiting rolling movement while providing further stability to the jack system 10. This effectively positions the jack system 10 from the movable load-bearing state to the stationary and braked state. The turning of the crank handle 40 in the opposite direction causes the pad 42 to move upwardly, and lowers the caster assemblies 22 and 23 as well as the display support 12, thereby returning the jack system 10 to the movable load-bearing state.

More than one jack assembly, such as jack assembly 21, can be used with a particular display support if desired. As shown in FIG. 1, jack assemblies 19 and 21 are attached at opposite sides of the display support 12. This two jack assembly configuration provides support for each end of the jack system 10 and can be used for supporting larger or heavier oversized loads or wall displays.

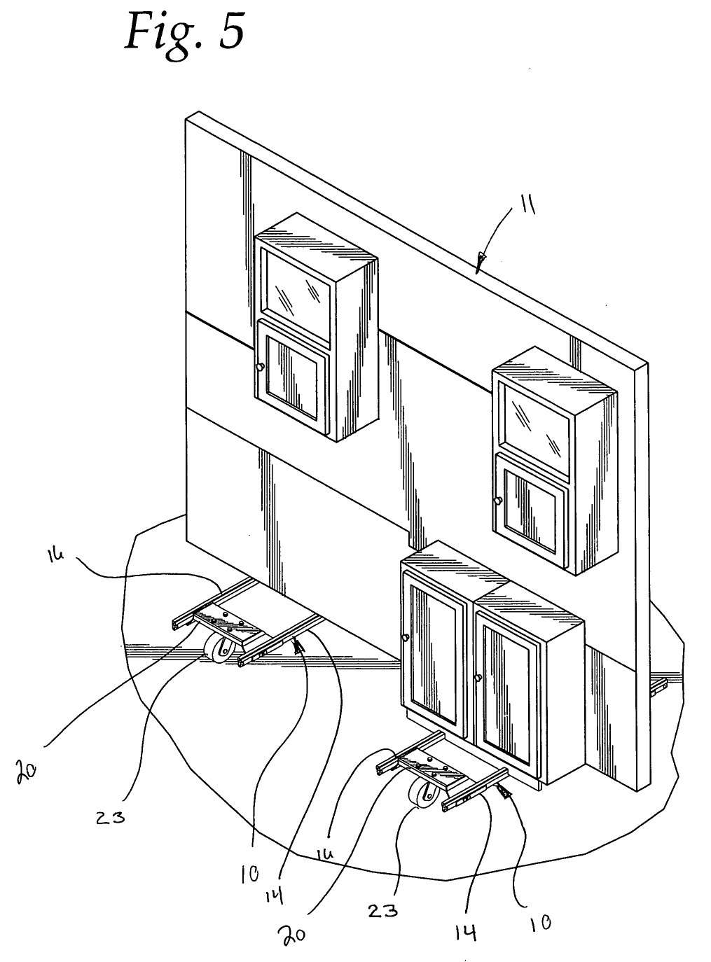

As shown in FIG. 5, it is also possible to use more than one jack system 10 to carry various display arrangements by resting a single wall display or load across the multiple display supports 12 aligned with respect to one another. This arrangement can also be used for wall displays that are large or oversized.

The foregoing description and the accompanying drawings are illustrative of the present invention. Still other variations and arrangements of parts are possible without departing from the spirit and scope of this invention.

I claim:

1. A jack system suitable for supporting display arrangements and positionable between a movable load-bearing state and a stationary state, the system comprising:
a display support adapted for supporting a wall display;
at least one caster assembly carried by the display support for rolling movement of the display support;
at least one jack stand on the display support; and
a jack carried by the jack stand.

2. The jack system of claim 1 wherein the display support includes a frame having a pair of spaced rails and the jack stand is slidably received on the spaced rails.

3. The jack system of claim 1 wherein the at least one jack stand is removable.

4. The jack system of claim 1 wherein the jack terminates in a pad adapted to engage a surface below the display support.

5. A jack system for supporting a wall display and positionable between a movable load-bearing state and a locked stationary state, the system comprising:
a display support frame having at least two generally parallel rails connected in a spaced relationship relative to one another by at least two bridge portions;
a caster assembly attached to each of the two bridge portions and adapted for rolling transport of the support frame; and
at least two removable jack assemblies carried by the two generally parallel rails;
wherein each jack assembly comprises a jack stand having a pair of depending legs and wherein each of the depending legs is adapted for slidable mounting onto one of the rails, and a jack is mounted to the jack stand.

6. The jack system of claim 5 wherein the jack further comprises a jack mounting plate for mounting the jack to an underneath portion of the jack stand.

7. The jack system of claim 5 wherein the jack is adapted for elevating the display support frame.

8. The jack system of claim 5 wherein the jack is adapted for elevating the at least one caster assembly.

9. The jack system of claim 5 wherein the jack is an axially translating screw jack.
